(19) United States
(12) Patent Application Publication
(10) Pub. No.: US 2002/0072337 A1
(43) Pub. Date: Jun. 13, 2002

(54) Cell phone shield

(76) Inventor: David Teller, Novato, CA (US)

Correspondence Address: David Teller, 530 Almeda del Prado, Novato, CA, 94949, US

(21) Appl. No.: 09/735,727

(22) Filed: Dec. 12, 2000

(51) Int. Cl. H04B 1/02

(52) U.S. Cl. 455/106; 455/90

(57) ABSTRACT

Cell Phone Shield with a foam padded ear piece, a double hinge mechanism attached to one side of the ear piece, a stationary flat panel attached to the hinge along one edge, a double sided adhesive panel attached to the stationary flat panel, the double sided adhesive attaching the flat panel to the reverse side of a cell phone corresponding to the location of the cell phones ear resting location, the double hinge having resilient members built in to cause said padded ear piece to remain in place whether in the storage position or the use position, and said double hinge having a floating post member to allow said ear piece to float outwards to accomodate cell phones of different thicknesses.

### BACKGROUND OF THE INVENTION

This invention relates generally to the field of ear shieds, and more particularly to a cell phone ear shield.

Cellular phones have been in wide spread use for several years. Recently, there has been wide speculation that having the ear piece of a cell phone close to the users ear for long periods of time can cause a potentially harmfull heat or radiation build up in the users head leading to potential brain tumors. It is also known that every fraction of an inch that a person can hold the cell phone away from his or her head can reduce the potential damage from heat or radiation. However , as the user places a distance between his or her ear and the speaker mechanism of the cell phone, the sound level becomes degaded to the point of being unable to hear the caller.

Attempts to remedy the problem of close proximity of a cell phone to a persons ear have included plugging in a remote ear piece which plugs into the phone so that the phone can be held a safe distance away from the user. A newer technology which is attempting to solve the problem is called “Blue Tooth” and involves a short range transmitter that transmits a cell phone signal from the cell phone to an ear piece without the need for wires from one to the other. In both cases, the user is required to deal with an extra piece of equipment that can be cumbersome and time consuming to use especially considering the instant use factor of receiving a phone call. There is therefore, a need for a method of protecting a person from the harmful effects of cell phone heat and radiation in a quick,simple and inexpensive way. The user should be able to easily install the protection device on outer surface of the phones ear piece housing so that the protective device can swing instantly into place and is always handy and quickly available.

### SUMMARY OF THE INVENTION

The primary object of the invention is to provide a method of shielding a persons ear and head from harmful cellular phone radiation.

Another object of the invention is to provide a method of easily attaching said cell phone sheild on a variety of cell phone models.

Another object of the invention is to provide a means to swing the sheild out of the way when the cell phone is not in use and easily swing it into position when the cell phone is in use.

Other objects and advantages of the present invention will become apparent from the following descriptions, taken in connection with the accompanying drawings, wherein, by way of illustration and example, an embodiment of the present invention is disclosed.

Cell Phone head and radiation protecting ear shield comprising: a foam padded ear piece, a double hinge mechanism attached to one side of said ear piece, a stationary flat panel attached to said hinge along one edge, a double sided adhesive panel attached to said stationary flat panel, said double sided adhesive attaching said flat panel to the reverse side of a cell phone corresponding to the location of the cell phones ear resting location, said double hinge having resilient members built in to cause said padded ear piece to remain in place whether in the storage position or the use position, and one of said hinges having a floating post member to allow said ear piece to float outwards to accomodate cell phones of different thicknesses.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is a perspective view of the protective ear piece assembly of the present invention in the storage position on a cell phone.

FIG. 2 is a perspective view of the cell phone as it is being opened for use.

FIG. 3 is a perspective view of the protective ear piece assembly of the present invention swung into the use position on the ear resting portion of the cell phone.

FIG. 4 is a top view of the protective ear piece assembly of the present invention in the storage position on a cell phone.

FIG. 5 is a top view of the protective ear piece assembly of the present invention in the use position on a cell phone.

FIG. 6 is a detail plan view of the attachment plate, hinge and foam ear piece of the present invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

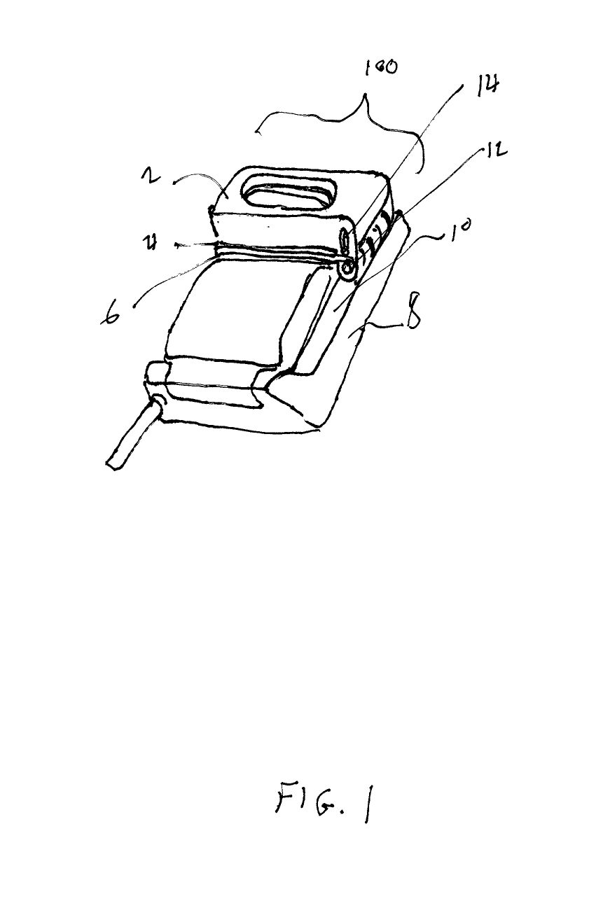

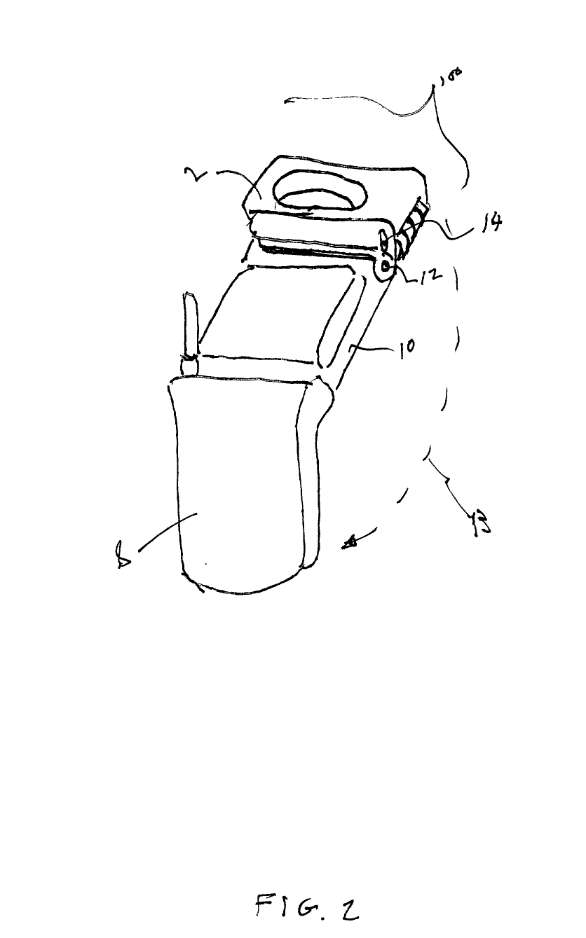

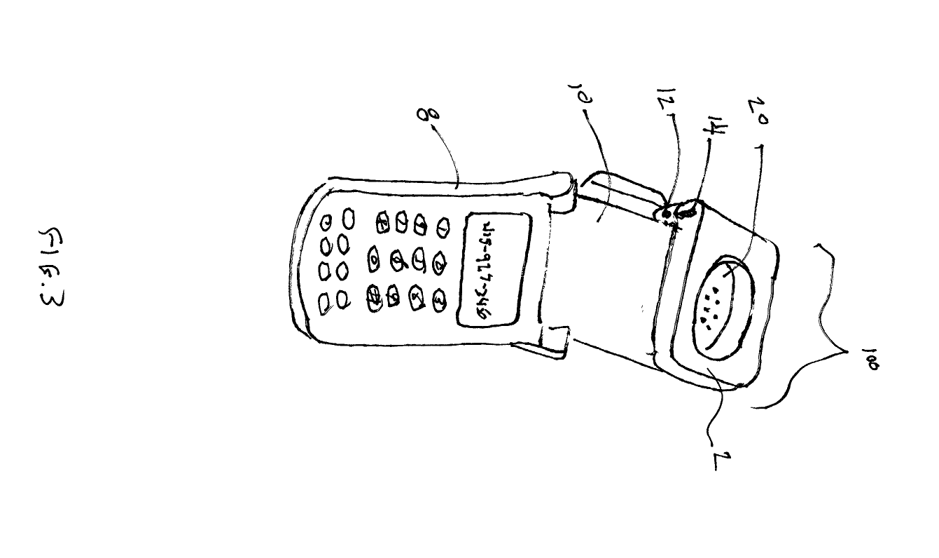

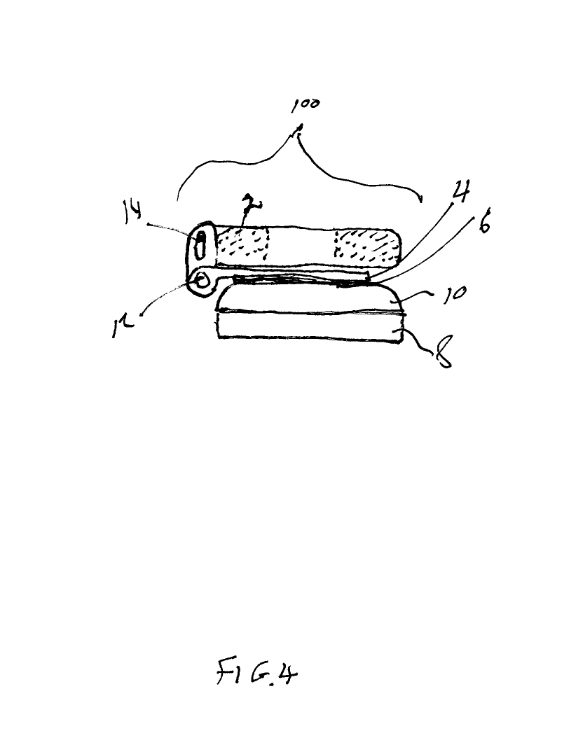

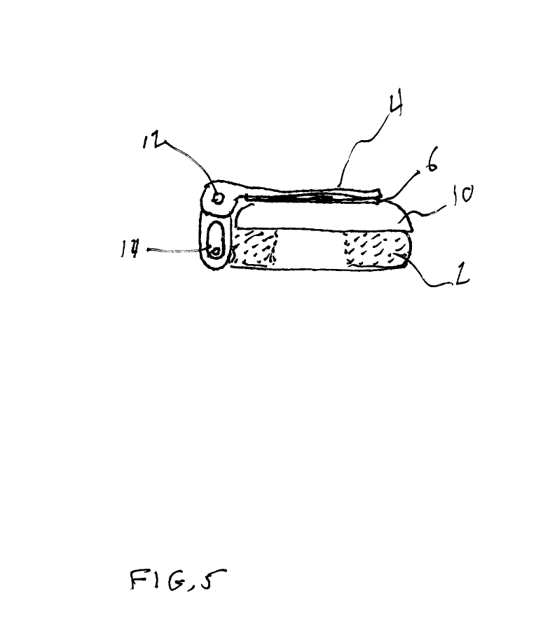

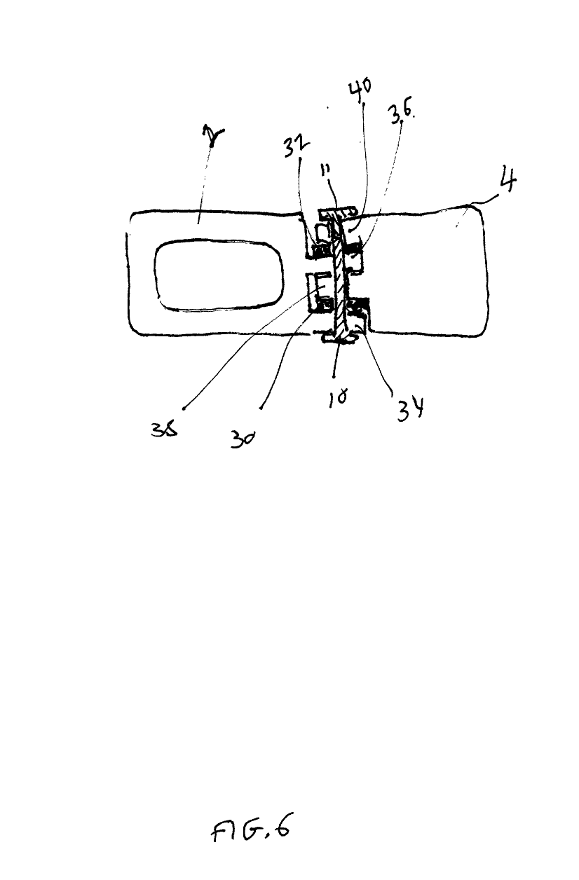

Referring now to FIG. 1 we see a perspective view of the heat and radiation protecting ear piece assembly 100 of the present invention as it is attached to the outside surface of the portion of a cell phone 10 that is opposite the ear resting area of the cell phone. In this configuration the protection assembly 100 is in the storage position. The protection assembly 100 is attached to the cell phone 10 by double sided adhesive 6, which is in turn attached to attachment plate 4. Attachment plate 4 is attached to hinge member 12. FIG. 2 shows how the key pad portion 8 of the cell phone can easily swing out in the normal fashion as shown by dotted line 13. Once the key pad portion of the cell phone 8 is swung to the open use positon, the protective ear pad assembly 100 can be rotated about its double hinge assembly 12, 14 so that the ear pad 2 is in place over the ear piece 20 of cell phone portion 10 as shown in FIG. 3. In this use position, the users ear is safely placed approximatly one half of one inch away from the cell phone ear resting portion 20. The soft foam construction of the ear protective ear pad 2 increases the users compfort level while talking and listening on the cell phone 10. FIG. 4 shows a top view of the heat and radiation protecting ear piece assembly 100 in the storage position. Double sided adhesive panel 6 holds flat hinged panel 4 in place onto the outside area of the cell phone 10 that alligns with the ear resting location on the inside area of cell phone 10. If the back of the cell phone is not flat, additional adhesive backed stand-offs can be provided to accomodate the curve. A double hinge assembly can be seen consisting of hinge points 12 and 14. Hinge point 12 is a simple post type hinge whereas hinge 14 is a floating type hinge that allows the foam ear pad 2 that is attached on one side to hinge 14 to float up or down to accomodate cell phones 10 of different thicknesses. FIG. 5 shows a top view of the cell phone ear piece section 10 and the heat and radiation protecting ear pad 2 in the use position. Notice that floating hinge pin 14 is in the extreem outward position to accomodate the thickness of cell phone ear piece section 10. FIG. 6 shows a partial section view of the hinge portion 10 of the present invention. Flat panel 4 is to be attached to the cell phone as previously described. Central hinge pin 10 is retained by threaded cap 11. Resilient washers 30, 32 a placed in compression when threaded cap 11 is locked in place. This compression acts frictionally against the hinge surfaces of swivel members 34, 36, 38, 40 so that wherever the user places protective ear pad 2, it tends to stay in that position. There is a similar plurality of resilient compression washers built into hinge member 14 as well. Therefore the protective pad will stay in the strorage position or the use position until the user desires to change positions.

In the above described and illustrated way, a person can easily add a heat and radiation protecting ear pad to a cell phone thereby reducing the chance of discomfort and possible brain tumors by prolonged use of a the cell phone. The device of the present invention is able to be applied to a variety of cell phone designs and becomes integral with the cell phone so that the user does not have to fumble for an additional piece of equipment such as a secondary ear piece.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Cell phone heat and radition protecting shield comprising:
a foam padded ear piece;
a double hinge mechanism attached to one side of said ear piece;
a stationary flat panel attached to said hinge along one edge;
a double sided adhesive panel attached to said stationary flat panel ;
said double sided adhesive attaching said flat panel to the reverse side of a cell phone corresponding to the location of the cell phones ear resting location;
said double hinge having resilient members built in to cause said padded ear piece to remain in place whether in the storage position or the use position; and
said double hinge having a floating post member to allow said protective ear piece pad to float outwards to accomodate cell phones of different thicknesses.
